(19) United States
(12) Patent Application Publication
(10) Pub. No.: US 2017/0223636 A1
(43) Pub. Date: Aug. 3, 2017

(54) COMMUNICATIONS SYSTEM AND COMMUNICATIONS METHOD

(71) Applicant: FUJITSU LIMITED, Kawasaki-shi (JP)

(72) Inventor: DAISUKE OGAWA, Yokosuka (JP)

(73) Assignee: FUJITSU LIMITED, Kawasaki-shi (JP)

(21) Appl. No.: 15/489,051

(22) Filed: Apr. 17, 2017

Related U.S. Application Data
(63) Continuation of application No. PCT/JP2014/079492, filed on Nov. 6, 2014.

(51) Int. Cl. H04W 52/16; H04L 5/00; H04L 25/02

(52) U.S. Cl. CPC H04W 52/16; H04L 25/0228; H04L 5/0048

(57) ABSTRACT

A communications system includes a transmission station configured to transmit data to plural reception stations by non-orthogonal multiplexing. The transmission station is further configured to transmit pilot signals to the plurality of reception stations by respective transmission powers corresponding to respective transmission powers of the data. The communications system further includes a reception station included in plural reception stations and configured to estimate the respective transmission powers of the data based on the pilot signals transmitted by the transmission station. The reception station is further configured to perform channel estimation between the transmission station and the reception station based on the estimated respective transmission powers.

### CROSS REFERENCE TO RELATED APPLICATIONS

This application is a continuation application of International Application PCT/JP2014/079492, filed on Nov. 6, 2014, and designating the U.S., the entire contents of which are incorporated herein by reference.

### FIELD

The embodiments discussed herein relate to a communications system and a communications method.

### BACKGROUND

Conventionally known wireless communication access techniques include Non-orthogonal Multiple Access (NOMA) in which transmission signals for multiple users are superimposed and sent on the same radio signal (see, e.g., Anass Benjebbour, Yuya Saito, Yoshihisa Kishiyama, Anxin Li, Atsushi Harada, Takehiro Nakamura, “Concept and Practical Considerations of Non-orthogonal Multiple Access (NOMA) for Future Radio Access”, International Symposium on Intelligent Signal Processing and Communication Systems (ISPACS), November 2013).

### SUMMARY

According to an aspect of an embodiment, a communications system includes a transmission station configured to transmit data to plural reception stations by non-orthogonal multiplexing. The transmission station is further configured to transmit pilot signals to the plural reception stations by respective transmission powers corresponding to respective transmission powers of the data. The communications system further includes a reception station included in the plural reception stations and configured to estimate the respective transmission powers of the data based on the pilot signals transmitted by the transmission station. The reception station is further configured to perform channel estimation between the transmission station and the reception station based on the estimated respective transmission powers.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram of an example of a communications system according to a first embodiment;

FIG. 2 is a diagram of an example of pairing of user terminals;

FIG. 3 is a diagram of an example of a ratio of transmission power to the user terminals;

FIG. 4 is a diagram of an example of a transmission signal and propagation path values from a base station;

FIG. 5 is a diagram of an example of signals transmitted by the base station according to the first embodiment;

FIG. 6A is a diagram of an example of the base station;

FIG. 6B is a diagram of an example of signal flow in the base station depicted in FIG. 6A;

FIG. 6C is a diagram of an example of hardware configuration of the base station;

FIG. 7A is a diagram of an example of a user terminal;

FIG. 7B is a diagram of an example of signal flow in the user terminal depicted in FIG. 7A;

FIG. 7C is a diagram of an example of hardware configuration of the user terminal;

FIG. 8A is a diagram of an example of a data demodulating/decoding unit of a user terminal (UE#1);

FIG. 8B is a diagram of an example of signal flow in the data demodulating/decoding unit depicted in FIG. 8A;

FIG. 9A is a diagram of an example of an estimating unit configured to estimate α, β;

FIG. 9B is a diagram of an example of signal flow in the estimating unit depicted in FIG. 9A;

FIG. 10 is a diagram of an example of information stored in a storage unit;

FIG. 11A is a diagram of an example of a data demodulating/decoding unit of a user terminal (UE#2);

FIG. 11B is a diagram of an example of signal flow in the data demodulating/decoding unit depicted in FIG. 11A;

FIG. 12 is a flowchart of an example of a process by the base station;

FIG. 13 is a flowchart of an example of a process by the user terminal (UE#1);

FIG. 14 is a flowchart of an example of a process of estimating α, β;

FIG. 15 is a flowchart of an example of a process by the user terminal (UE#2);

FIG. 16 is a diagram of a modification example of the information stored in the storage unit;

FIG. 17A is a diagram of a modification example of the data demodulating/decoding unit of the user terminal (UE#1);

FIG. 17B is a diagram of an example of signal flow in the modification example of the data demodulating/decoding unit depicted in FIG. 17A; and

FIG. 18 is a diagram of an example of signals transmitted by the base station according to a second embodiment.

### DESCRIPTION OF THE INVENTION

Embodiments of a communications system and a communications method according to the present invention will be described in detail with reference to the accompanying drawings.

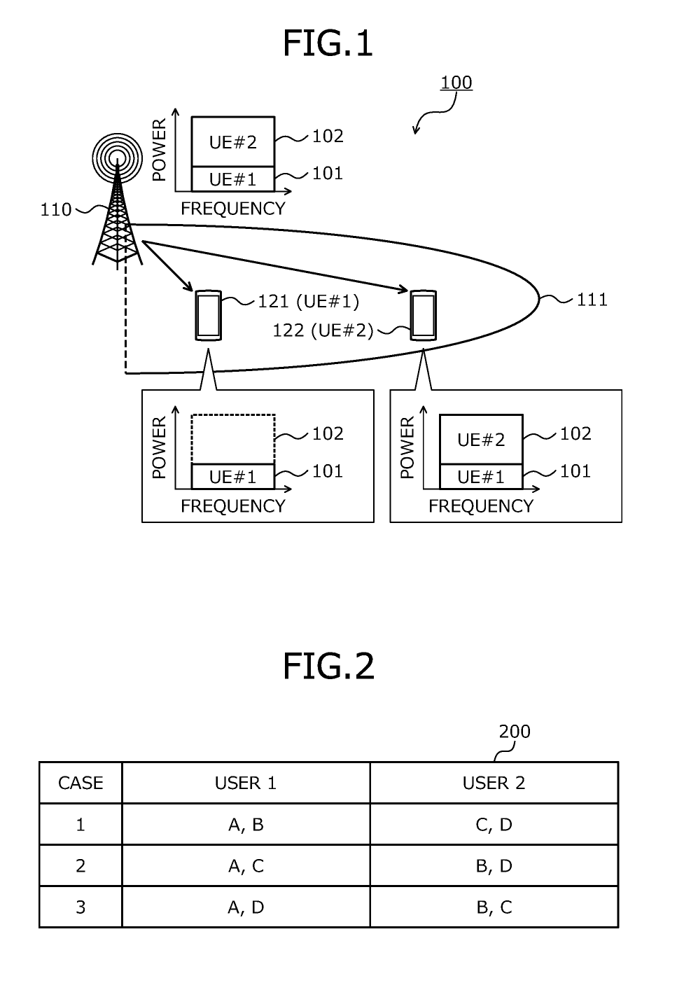

FIG. 1 is a diagram of an example of a communications system according to a first embodiment. As depicted in FIG. 1, a communications system 100 according to the first embodiment includes a base station 110 and user terminals 121, 122 (UE#1, UE#2). The user terminals 121, 122 (User Equipment (UE)) are located within a cell 111 of the base station 110. In the communications system 100, communication according to NOMA is performed such that the base station 110 (transmission station) multiplexes and transmits respective data to the user terminals 121, 122 (reception stations) in a non-orthogonal state.

The user terminals 121, 122 have differing reception qualities from the base station 110. Reception quality is the reception power of a received radio signal, for example. The reception quality is reported from the user terminals 121, 122 to the base station 110 by using a Channel Quality Indicator (CQI), Channel State Information (CSI), etc. The reception quality at the user terminals 121, 122 is determined by the distance from the base station 110, for example. Additionally, the reception quality at the user terminals 121, 122 may change in some cases due to obstacles, etc. between the base station 110 and the user terminals 121, 122.

For instance, in the example depicted in FIG. 1, the user terminal 121 is closer to the base station 110 than the user terminal 122 is, and therefore has a higher reception quality from the base station 110 than that of the user terminal 122. In this case, the base station 110 makes the transmission power to the user terminal 122 located farther from the base station 110 larger than the transmission power to the user terminal 121 located closer to the base station 110. As a result, NOMA may be performed such that respective data to the user terminals 121, 122 are multiplexed and transmitted in a non-orthogonal state and such that the user terminals 121, 122 demultiplex and receive the respective data therefor.

Data 101 is information from the base station 110 to the user terminal 121 (UE#1). The data 102 is information from the base station 110 to the user terminal 122 (UE#2). In the example depicted in FIG. 1, the base station 110 simultaneously transmits the data 101, 102 at the same frequency with the transmission power of the data 102 made larger than the transmission power of the data 101.

The user terminal 121 may estimate the data 102 to the user terminal 122, non-orthogonally multiplexed by the base station 110 and cancel (subtract) the estimation result from the received signal to thereby extract the data 101 to the user terminal 121. Estimating means to calculate an estimated value. For example, estimating data is to calculate an estimated value of data.

As described above, a large transmission power is assigned to the data 102 destined to the user terminal 122. Therefore, the data 102 to the user terminal 122 has a high signal to interference and noise ratio (SINR). Thus, the user terminal 121 may estimate the data 102 destined to the user terminal 122 with high accuracy.

Additionally, a larger transmission power is assigned to the data 102 destined to the user terminal 122 than to the data 101 destined to the user terminal 121. The user terminal 122 is farther from the base station 110 than the user terminal 121 is. In the communications system 100, multiple cells are actually present other than the cell 111. Therefore, the user terminal 121 and the user terminal 122 receive radio waves from cells other than the cell 111 as interference waves. In particular, the user terminal 122 located farther from the base station 110 receives more interference waves from sources other than the base station 110.

As a result, in the user terminal 122, the reception power of the data 101 to the user terminal 121 is buried in the interference wave reception power. Therefore, the user terminal 122 demodulates the data 102 to the user terminal 122 without estimating/canceling the data 101 to the user terminal 121.

FIG. 2 is a diagram of an example of pairing of user terminals. To perform communication according to NOMA, the base station 110 pairs user terminals located in the cell 111 of the base station 110. The pairing may be performed based on the reception quality reported by the user terminals to the base station 110. For example, the base station 110 performs the pairing based on the transmission power of multiple users such that the system capacity of NOMA is maximized.

In the example depicted in FIG. 2, it is assumed that user terminals A to D compatible with NOMA are located in the cell 111 of the base station 110. It is also assumed that non-orthogonal multiplexing is performed for two user terminals. In this case, as in pairing candidates 200 depicted in FIG. 2, three patterns of pairing are considered as candidates.

Case 1 is a case where the user terminals A, B make a user pair 1 while the user terminals C, D make a user pair 2. In Case 1, the base station 110 determines an optimum transmission power to the user terminals A, B when the user terminal A and the user terminal B are non-orthogonally multiplexed, and further determines an optimum transmission power to the user terminals C, D when the user terminals C, D are non-orthogonally multiplexed. As a result, the system capacity of NOMA in the case of Case 1 is determined.

Similarly, the base station 110 also calculates the NOMA system capacities for Cases 2, 3 and selects the Case having the largest system capacity among Cases 1 to 3. The user terminals 121, 122 depicted in FIG. 1 are pairs in the Case selected by the base station 110 in this way.

Although such a full-searching technique is a technique that increases the system capacity, since the degree of freedom of setting the transmission power is large, if a determined transmission power is reported to the user terminals through power control information (transmission power information), a huge number of bits is required for the power control information. Therefore, Anass Benjebbour, et al in “Concept and Practical Considerations of Non-orthogonal Multiple Access (NOMA) for Future Radio Access” propose to reduce the number of bits of the power control information transmitted to the user terminals by quantizing the range of transmission power setting.

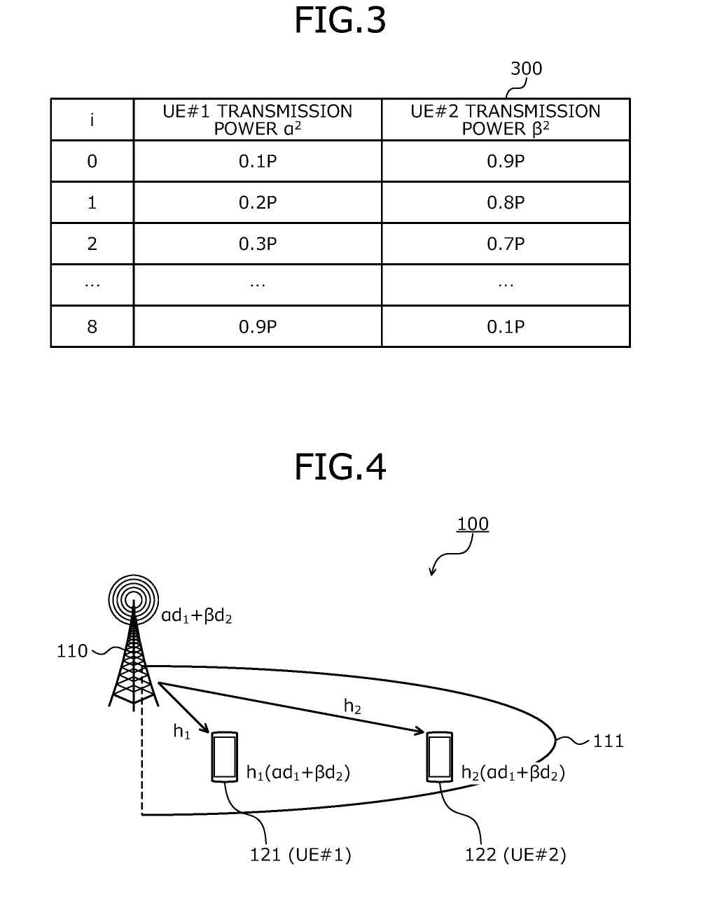

FIG. 3 is a diagram of an example of a ratio of transmission power to the user terminals. A table 300 depicted in FIG. 3 describes candidates of the ratio of the transmission powers from the base station 110 to the user terminals 121, 122 set in the communications system 100. An index of the candidates is denoted by i. The transmission power to the user terminal 121 (UE#1) is denoted by α². The transmission power to the user terminal 122 (UE#2) is denoted by β².

The base station 110 performs data transmission through non-orthogonal multiplexing to the user terminals 121, 122 according to the ratio of transmission powers selected from the candidates in the table 300. For example, if the transmission power ratio (0.1P, 0.9P) corresponding to i=0 is selected, the base station 110 transmits data at the transmission power ratio of 1:9 to the user terminals 121, 122.

The base station 110 spreads respective reference signals (RSs) to the user terminals 121, 122 with orthogonal codes for transmission. As a result, the respective RSs to the user terminals 121, 122 may be multiplexed and transmitted. The user terminals 121, 122 may despread the respective RSs included in the received signal from the base station 110 so as to demultiplex and receive the respective RSs.

The base station 110 sets the transmission powers of the respective RSs to the user terminals 121, 122 to α², β² that are the same as the transmission powers of the data to the user terminals 121, 122, respectively. As a result, α², β² may be estimated from the respective RSs included in the received signal at the user terminals 121, 122 on the reception side. Therefore, even if α², β² are not reported through control information directly indicative of α², β² from the base stations 110 to the user terminals 121, 122, the user terminals 121, 122 may demodulate the non-orthogonally multiplexed data. The RSs are pilot signals transmitted individually to the user terminals.

In the example depicted in FIG. 3, the candidates of the transmission power ratio of the table 300 are described as transmission power ratios at which the transmission powers to the user terminals 121, 122 are changed by 0.1. However, the candidates of the transmission power ratio from the base station 110 to the user terminals 121, 122 is not limited hereto and may suitably be set.

FIG. 4 is a diagram of an example of a transmission signal and propagation path values from a base station. In FIG. 4, portions identical to those depicted in FIG. 1 are denoted by the same reference numerals used in FIG. 1 and will not be described. The data from the base station 110 to the user terminal 121 (UE#1) is denoted by d₁. The data from the base station 110 to the user terminal 122 (UE#2) is denoted by d₂.

The number of antennas used by the base station 110 for transmitting radio signals is assumed to be one. The number of antennas used by the user terminal 121 for receiving radio signals is assumed to be one. The number of antennas used by the user terminal 122 for receiving radio signals is assumed to be one. The propagation path value between the base station 110 and the user terminal 121 is assumed to be h₁. The propagation path value between the base station 110 and the user terminal 122 is assumed to be h₂.

Based on the ratio (α², β²) selected from the table 300 depicted in FIG. 3, the base station 110 transmits αd₁+βd₂ as a NOMA multiplexed signal to the user terminals 121, 122. In this case, since the propagation path value between the base station 110 and the user terminal 121 is h₁, the received signal at the user terminal 121 is h₁(αd₁+βd₂). Additionally, since the propagation path value between the base station 110 and the user terminal 122 is h₂, the received signal at the user terminal 122 is h₂(αd₁+βd₂).

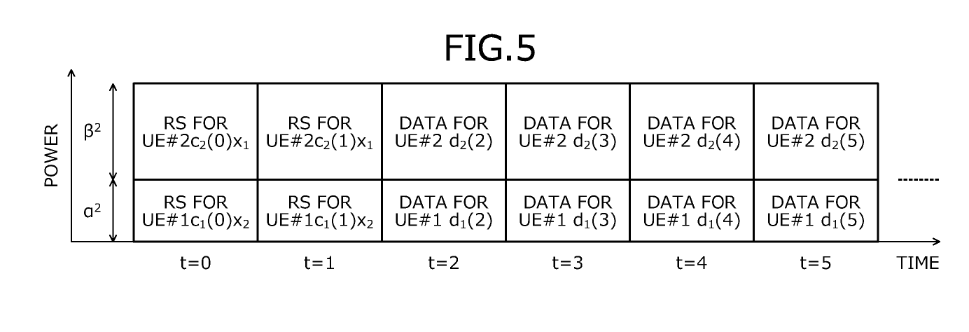

FIG. 5 is a diagram of an example of signals transmitted by the base station according to the first embodiment. In FIG. 5, the horizontal axis represents time and the vertical axis represents power (Power). At time t=2, 3, . . . , the base station 110 transmits d₁(2), d₁(3), . . . that are data to the user terminal 121 (Data for UE#1) and d₂(2), d₂(3), . . . that are data to the user terminal 122 (Data for UE#2), through non-orthogonal multiplexing.

In this case, the base station 110 sets the transmission power to α² for d₁(2), d₁(3), . . . that are data to the user terminal 121 and sets the transmission power to β² for d₂(2), d₂(3), . . . that are data to the user terminal 122.

At time t=0, the base station 110 transmits c₁(0)x₂ that is the RS to the user terminal 121 (RS for UE#1) and c₂(0)x₁ that is the RS to the user terminal 122 (RS for UE#2) through a spreading process using orthogonal codes. At time t=1, the base station 110 transmits c₁(1)x₂ that is the RS to the user terminal 121 (RS for UE#1) and c₂(1)x₁ that is the RS to the user terminal 122 (RS for UE#2) through a spreading process using orthogonal codes.

In this description, c₁(0) and c₁(1) are orthogonal codes corresponding to the user terminal 121 (UE#1) at time t=0, 1. Similarly, c₂(0) and c₂(1) are orthogonal codes corresponding to the user terminal 122 (UE#2) at time t=0, 1. For instance, c₁(0)=1, c₁(1)=1, c₂(0)=1, and c₂(1)=−1 may be used.

The base station 110 sets the transmission power of the RSs c₁(0)x₂, c₁ (1)x₂ to the user terminal 121 to α², which is the same as the transmission power of the data d₁(2), d₁(3), . . . to the user terminal 121. The base station 110 sets the transmission power of the RSs c₂(0)x₁, c₂(1)x₁ to the user terminal 122 to β², which is the same as the transmission power of the data d₂(2), d₂(3), . . . to the user terminal 122.

This enables the user terminals 121, 122 to estimate α², β² based on the powers of the respective RSs at time t=0, 1. The user terminal 121 may demodulate d₁(2), d₁(3), . . . based on the estimated α², β². The user terminal 122 may demodulate d₂(2), d₂(3), . . . based on the estimated α², β².

In the example depicted in FIG. 5, description has been made of a case where the RSs and the data are assigned to respective time resources with the horizontal axis defined as the time axis; however, the RSs and the data may be assigned to respective frequency resources with the horizontal axis defined as the frequency axis. In the following description, the RSs and the data are assigned to respective time resources.

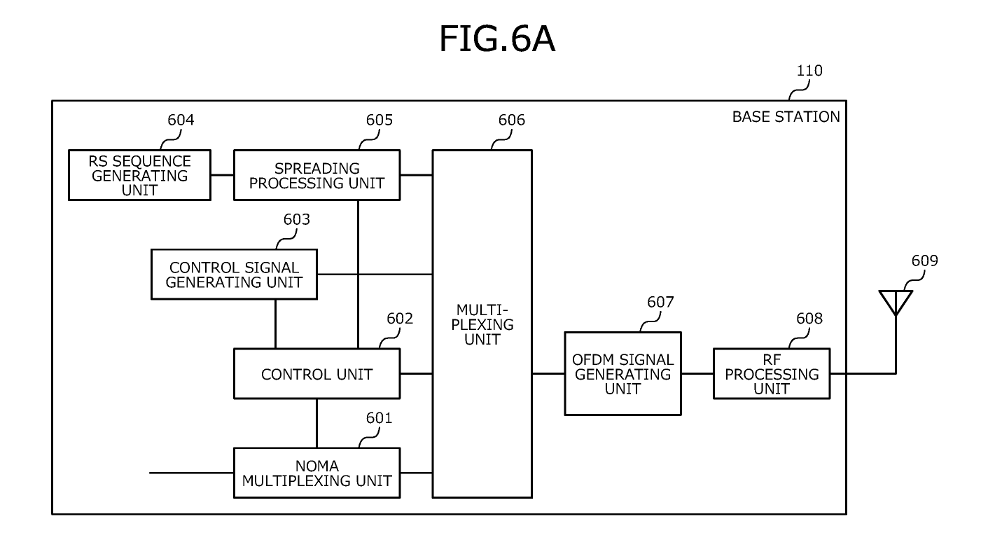

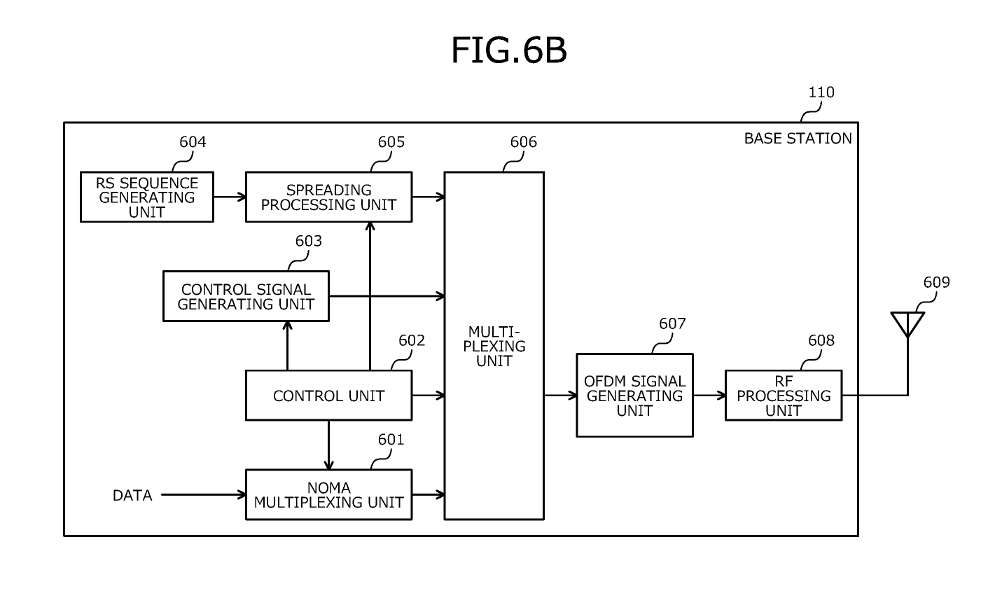

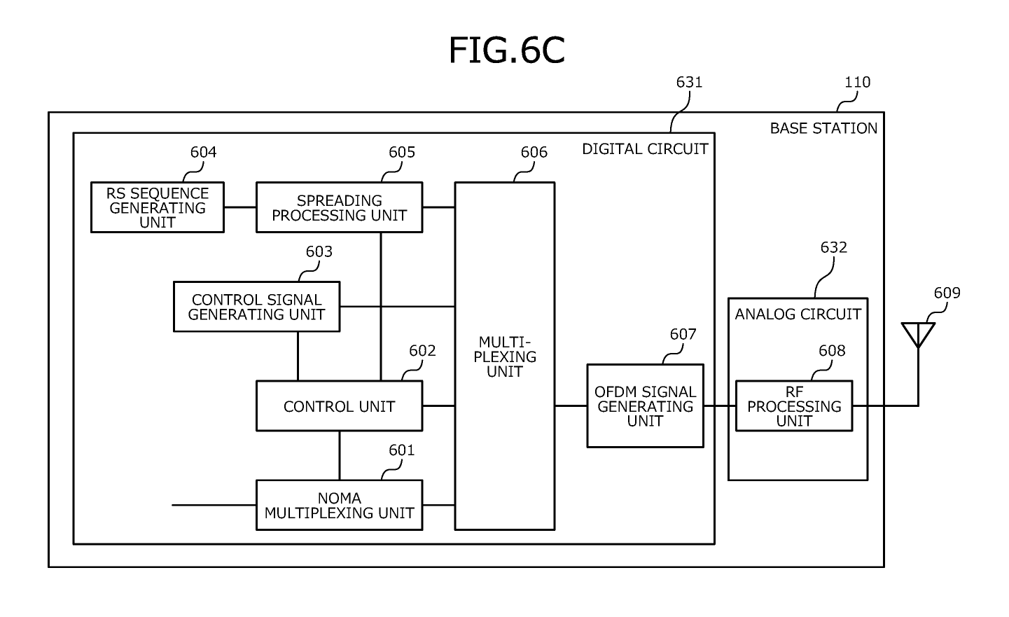

FIG. 6A is a diagram of an example of a base station. FIG. 6B is a diagram of an example of signal flow in the base station depicted in FIG. 6A. In the examples depicted in FIGS. 6A and 6B, a configuration of the base station 110 is described in a case of applying Orthogonal Frequency Division Multiplexing (OFDM) to the base station 110 for transmission. It is noted that the description will be made with respect to one certain frequency (one subcarrier) (see, for example, FIG. 5).

As depicted in FIGS. 6A and 6B, the base station 110 includes a NOMA multiplexing unit 601, a control unit 602, a control signal generating unit 603, an RS sequence generating unit 604, and a spreading processing unit 605. The base station 110 includes a multiplexing unit 606, an OFDM signal generating unit 607, an RF processing unit 608, and an antenna 609.

Respective data (user data) to be transmitted to the user terminals 121, 122 are input to the NOMA multiplexing unit 601. The NOMA multiplexing unit 601 performs an error correction process and a modulation process for input data for each of the user terminals and nonlinearly multiplexes the data of the user terminals subjected to the processes. For example, the NOMA multiplexing unit 601 performs the processes based on scheduling information output from the control unit 602. The scheduling information includes, for example, adaptive modulation and coding (AMC) information for each of the user terminals and information indicating the user terminals for which non-orthogonal multiplexing is performed. The scheduling information also includes α², β² described above.

For the error correction process by the NOMA multiplexing unit 601, for example, turbo codes may be used. For the modulation process by the NOMA multiplexing unit 601, N- (e.g., 4- or 16-) quadrature amplitude modulation (QAM) etc. can be used. The NOMA multiplexing unit 601 outputs to the multiplexing unit 606, a data signal obtained by nonlinear multiplexing. The data signal is, for example, αd₁+βd₂ described above.

The control unit 602 controls transmission to the user terminals present in the cell 111 of the base station 110. For example, the control unit 602 performs scheduling of the user terminals and outputs scheduling information indicating a scheduling result to the NOMA multiplexing unit 601, the control signal generating unit 603, and the multiplexing unit 606. The control unit 602 also outputs c₁(0), c₁(1), c₂(0), c₂(1) and α², β² described above to the spreading processing unit 605 as orthogonal codes for the spreading process of the RSs.

The control signal generating unit 603 generates a control signal based on the scheduling information output from the control unit 602. The control signal generated by the control signal generating unit 603 includes a control signal, a synchronization signal, a reporting signal, etc. required for demodulation of user data on the receiving side (e.g., the user terminals 121, 122). The control signal generating unit 603 outputs the generated control signal to the multiplexing unit 606.

The RS sequence generating unit 604 generates an RS sequence x₁ for the user terminal 121 (UE#1) and an RS sequence x₂ for the user terminal 122 (UE#2). It is noted that x₁ and x₂ may be the same RS sequences. The RS sequence generating unit 604 outputs the generated RS sequences to the spreading processing unit 605.

The spreading processing unit 605 performs the spreading process of the RS sequences output from the RS sequence generating unit 604 based on the orthogonal codes c₁(0), c₁(1), c₂(0), c₂(1) output from the control unit 602. The spreading process by the spreading processing unit 605 is, for example, code division multiplexing (CDM).

For example, the spreading processing unit 605 performs the spreading process by calculating c₁(0)x₁, c₁(1)x₁, c₂(0)x₂, c₂(1)x₂ based on x₁, x₂ (RS sequences) from the RS sequence generating unit 604 and c₁(0), c₁(1), c₂(0), c₂(1). To transmit the RS sequences with the same power as the data signal, the spreading processing unit 605 calculates a signal represented by equation (1) by using the transmission powers α², β² output from the control unit 602, and outputs the calculated signal to the multiplexing unit 606.

αc₁(t)x₁+βc₂(t)x₂ (1)

The multiplexing unit 606 multiplexes the data signal from the NOMA multiplexing unit 601, the control signal from the control signal generating unit 603, and the RS sequences from the spreading processing unit 605 based on the scheduling information output from the control unit 602. Since OFDM is used in the example depicted in FIGS. 6A and 6B, the multiplexing unit 606 performs the multiplexing by determining which resource element (RE) each signal is mapped to, based on the scheduling information output from the control unit 602. The multiplexing unit 606 then outputs the multiplexed signal to the OFDM signal generating unit 607.

The OFDM signal generating unit 607 executes an OFDM process on the signal output from the multiplexing unit 606. The OFDM process by the OFDM signal generating unit 607 includes, for example, inverse fast Fourier transform (IFFT) and insertion of a cyclic prefix (CP). IFFT converts a signal from the frequency domain to the time domain. The OFDM signal generating unit 607 outputs to the RF processing unit 608, a signal (an OFDM signal) obtained from the OFDM process.

The RF processing unit 608 performs a radio frequency (RF) process on the signal output from the OFDM signal generating unit 607. The RF process by the RF processing unit 608 includes, for example, conversion from a digital signal to an analog signal, frequency conversion from a baseband to a radio frequency band, and amplification. The RF processing unit 608 outputs to the antenna 609, the signal subjected to the RF process. The antenna 609 transmits the signal output from the RF processing unit 608 to other communication devices (e.g., the user terminals 121, 122) by radio.

In the NOMA system, since each user terminal may act as either of the user terminals 121, 122, each user terminal has functions corresponding to the user terminals 121, 122. Switching of each user terminal between the user terminals 121, 122 is performed by the control unit 602 of the base station 110, for example.

FIG. 6C is a diagram of an example of hardware configuration of the base station. In FIG. 6C, constituent elements identical to those in FIGS. 6A and 6B are denoted by the same reference numerals used in FIGS. 6A and 6B and will not be described. As depicted in FIG. 6C, the NOMA multiplexing unit 601, the control unit 602, the control signal generating unit 603, the RS sequence generating unit 604, the spreading processing unit 605, the multiplexing unit 606, and the OFDM signal generating unit 607 depicted in FIGS. 6A and 6B may be implemented by a digital circuit 631, for example. For the digital circuit 631, for example, a dedicated digital circuit may be used, or a general-purpose circuit such as a digital signal processor (DSP) and a central processing unit (CPU) may be used.

The RF processing unit 608 may be implemented by an analog circuit 632. The analog circuit 632 includes, for example, a digital/analog converter (DAC), a conversion circuit including a multiplier, an oscillator, etc., and an amplifier.

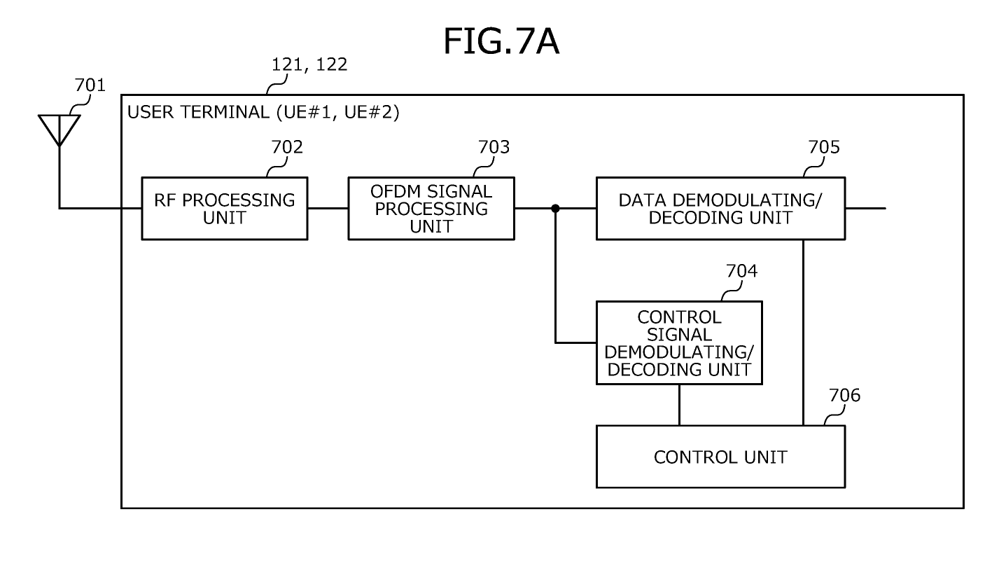

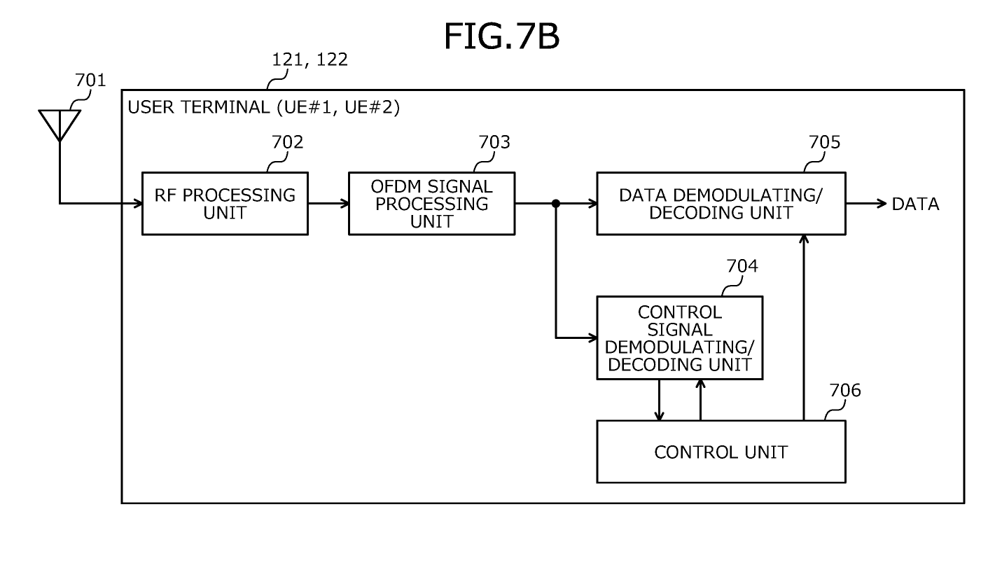

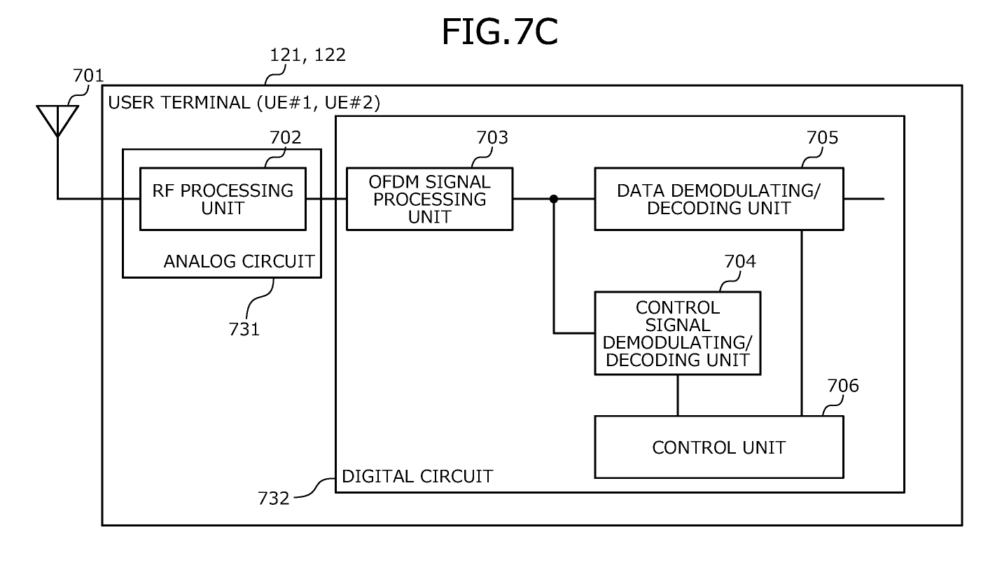

FIG. 7A is a diagram of an example of a user terminal. FIG. 7B is a diagram of an example of signal flow in the user terminal depicted in FIG. 7A. In the examples depicted in FIGS. 7A and 7B, a configuration of the user terminals 121, 122 is described in the case of applying OFDM to the user terminals 121, 122 for reception. As depicted in FIGS. 7A and 7B, each of the user terminals 121, 122 includes an antenna 701, an RF processing unit 702, an OFDM signal processing unit 703, a control signal demodulating/decoding unit 704, a control unit 706, and a data demodulating/decoding unit 705.

The antenna 701 receives a signal transmitted by radio from another communication device. The antenna 701 then outputs the received signal to the RF processing unit 702. The RF processing unit 702 executes an RF process on the signal output from the antenna 701. The RF process by the RF processing unit 702 includes, for example, amplification, frequency conversion from a radio frequency band to a baseband, and conversion from an analog signal to a digital signal. The RF processing unit 702 outputs the signal subjected to the RF process to the OFDM signal processing unit 703.

The OFDM signal processing unit 703 executes an OFDM process on the signal output from the RF processing unit 702. The OFDM process by the OFDM signal processing unit 703 includes, for example, removal of CP and fast Fourier transform (FFT). FFT converts a signal from the time domain to the frequency domain. The OFDM signal processing unit 703 outputs, as a received signal, the signal subjected to the OFDM process to the control signal demodulating/decoding unit 704 and the data demodulating/decoding unit 705.

The control signal demodulating/decoding unit 704 obtains from the control unit 706, information for demodulation and decoding. Based on the obtained information, the control signal demodulating/decoding unit 704 demodulates and decodes a control signal, a synchronization signal, report information, etc. included in the received signal output from the OFDM signal processing unit 703. The control signal demodulating/decoding unit 704 then outputs the control signal, the synchronization signal, the report information, etc. obtained by the demodulation and decoding to the control unit 706.

The data demodulating/decoding unit 705 obtains, from the control unit 706, information for demodulation and decoding. Based on the obtained information, the data demodulating/decoding unit 705 demodulates and decodes data (user data) included in the received signal output from the OFDM signal processing unit 703. The data demodulating/decoding unit 705 then outputs the decoded data. The control unit 706 outputs the information for demodulation and decoding to the control signal demodulating/decoding unit 704 and the data demodulating/decoding unit 705.

FIG. 7C is a diagram of an example of hardware configuration of the user terminal. In FIG. 7C, constituent elements identical as those in FIGS. 7A and 7B are denoted by the same reference numerals used in FIGS. 7A and 7B and will not be described. As depicted in FIG. 7C, the RF processing unit 702 depicted in FIGS. 7A and 7B may be implemented by an analog circuit 731. The analog circuit 731 includes, for example, an amplifier, a conversion circuit including a multiplier, an oscillator, etc., and an analog/digital converter (ADC).

The OFDM signal processing unit 703, the control signal demodulating/decoding unit 704, the data demodulating/decoding unit 705, and the control unit 706 may be implemented by, for example, a digital circuit 732. For the digital circuit 732, for example, a dedicated digital circuit may be used, or a general-purpose circuit such as a DSP and a CPU may be used.

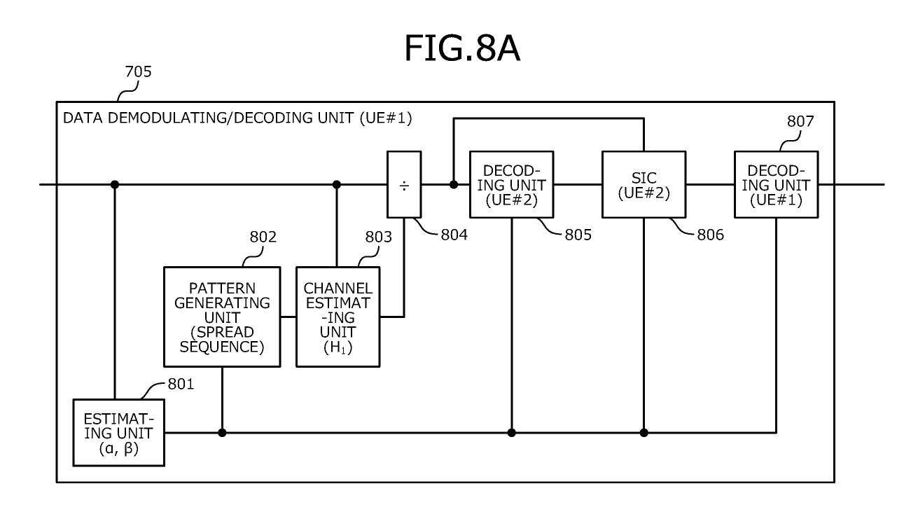

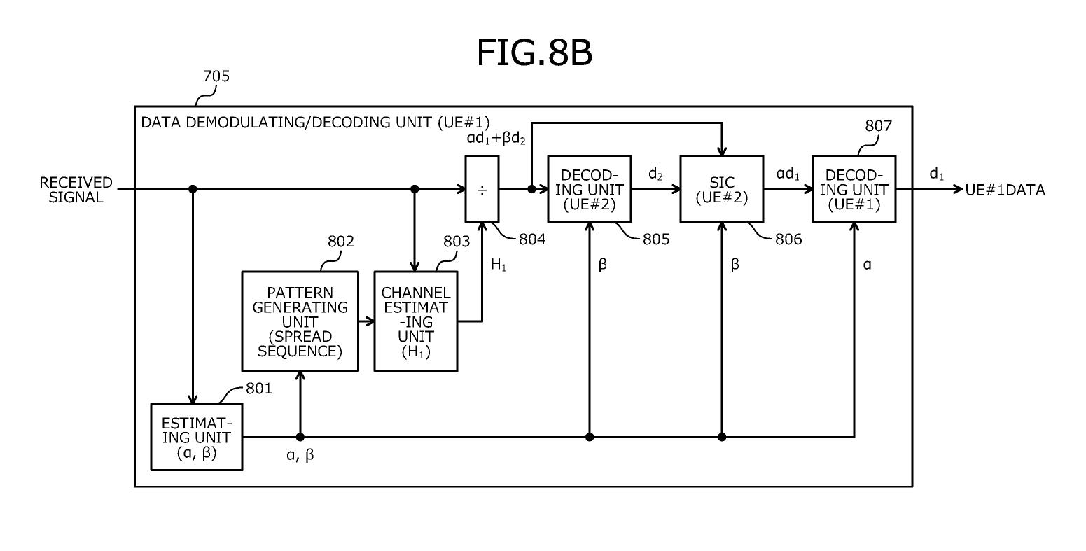

FIG. 8A is a diagram of an example of the data demodulating/decoding unit of the user terminal (UE#1). FIG. 8B is a diagram of an example of signal flow in the data demodulating/decoding unit depicted in FIG. 8A. In FIGS. 8A and 8B, the user terminal 121 (UE#1) closer to the base station 110 will be described among the user terminals 121, 122. It is noted that although the user terminal 121 depicted in FIGS. 7A and 7B has a configuration compatible with OFDM, the description will be made with respect to one certain frequency (one subcarrier) (see, e.g., FIG. 5).

As depicted in FIGS. 8A and 8B, the data demodulating/decoding unit 705 of the user terminal 121 includes an estimating unit 801, a pattern generating unit 802, a channel estimating unit 803, a dividing unit 804, a decoding unit 805, an SIC 806, and a decoding unit 807.

The received signal output from the OFDM signal processing unit 703 is input to the estimating unit 801, the channel estimating unit 803, and the dividing unit 804. Received signals z₁(0), z₁(1), z₁(2) at times t=0, 1, 2 in the user terminal 121 are expressed by equations (2) to (4). A noise component is ignored.

z₁(0)=h₁(0){αc₁(0)x₁+βc₂(0)x₂} (2)

z₁(1)=h₁(1){αc₁(1)x₁+βc₂(1)x₂} (3)

z₁(2)=h₁(2){αd₁(2)x₁+βd₂(2)} (3)

The estimating unit 801 estimates α and β from the received signals z₁(0), z₁(1) for times t=0, 1. An estimating process of α and β by the estimating unit 801 will be described later. The estimating unit 801 outputs the estimated α and β to the pattern generating unit 802. The estimating unit 801 also outputs the estimated β to the decoding unit 805 and the SIC 806. The estimating unit 801 also outputs the estimated α to the decoding unit 807.

Based on α and β output from the estimating unit 801, the pattern generating unit 802 generates spread sequences for times t=0, 1 from equations (5) and (6). The spread sequences are signals corresponding to RSs after spreading transmitted by the base station 110.

αc₁(0)x₁+βc₂(0)x₂ (5)

αc₁(1)x₁+βc₂(1)x₂ (6)

In equations (5) and (6), x1 and x2 are the RS sequences generated for the user terminals 121, 122 by the RS sequence generating unit 604 of the base station 110. Additionally, c₁(0), c₁(1), c₂(0), c₂(1) are the orthogonal codes corresponding to the user terminals 121, 122. These parameters are shared among the base station 110 and the user terminals 121, 122 at the time of the pairing of the user terminals 121, 122 by the base station 110, for example. The pattern generating unit 802 outputs the generated sequences (patterns) to the channel estimating unit 803.

The channel estimating unit 803 performs channel estimation for estimating an impulse response of a propagation path. For example, based on the received signals z₁(0), z₁(1) at time t=0, 1 and the sequences output from the pattern generating unit 802, the channel estimating unit 803 calculates propagation path values h₁(0), h₁(1) between the base station 110 and the user terminal 121 for times t=0, 1. For example, the channel estimating unit 803 calculates h₁(0), h₁(1) from equations (7) and (8).

$$\begin{matrix}\frac{{z}_{1} ( 0 )}{α {c}_{1} ( 0 ) {x}_{1} + β {c}_{2} ( 0 ) {x}_{2}} = {h}_{1} ( 0 ) & ( 7 ) \\ \frac{{z}_{1} ( 1 )}{α {c}_{1} ( 1 ) {x}_{1} + β {c}_{2} ( 1 ) {x}_{2}} = {h}_{1} ( 1 ) & ( 8 )\end{matrix}$$

Although the noise component is ignored in equations (7) and (8), the noise component cannot be ignored in the actual environment. A process of reducing the noise component is generally executed in the channel estimation. A case of using the channel estimation will be described as an example of the process of reducing the noise component.

If variation in the propagation path between the base station 110 and the user terminal 121 is a sufficiently gradual variation between t=0 and t=1, a channel estimation value H₁ between the base station 110 and the user terminal 121 may be obtained by averaging the propagation path values h₁(0), h₁(1) as represented by equation (9).

$${H}_{1} = \frac{{h}_{1} ( 0 ) + {h}_{1} ( 1 )}{2} \qquad ( 9 )$$

The channel estimating unit 803 outputs to the dividing unit 804, the H₁ obtained from equation (9) as the channel estimation value. In this way, the user terminal 121 generates a sequence in which the RSs (pilot signals) are spread with the orthogonal codes based on the estimated transmission powers (α², β²) of data, and performs the channel estimation between the base station 110 and the user terminal 121 based on the generated sequence. As a result, the channel between the base station 110 and the user terminal 121 may be estimated accurately.

To obtain the data at time t=2, the dividing unit 804 performs division according to equation (10) based on the received signal z₁(2) at time t=2 and the H₁ output from the channel estimating unit 803.

$$\frac{{y}_{1} ( 2 )}{{H}_{1}} = \frac{{h}_{1} ( 2 ) \{ α {d}_{1} ( 2 ) + β {d}_{2} ( 2 ) \}}{{H}_{1}} \qquad ( 10 )$$

If the channel variation is sufficiently gradual, equation (11) holds whereby equation (10) described above is expressed as equation (12).

$$\begin{matrix}{h}_{1} ( 2 ) \approx {H}_{1} & ( 11 ) \\ \frac{{y}_{1} ( 2 )}{{H}_{1}} = α {d}_{1} ( 2 ) + β {d}_{2} ( 2 ) & ( 12 )\end{matrix}$$

Therefore, the dividing unit 804 may obtain αd₁+βd₂ from the division according to equation (10) as a signal that is the received signal compensated with the channel estimation value. The dividing unit 804 outputs to the decoding unit 805 and the SIC 806, αd₁+βd₂ obtained from the division.

The decoding unit 805 demodulates the data d₂(2) to the user terminal 122 (#2) included in the received signal, based on αd₁+βd₂ output from the dividing unit 804. In this case, for example, N-QAM is applied to d₂(2) and, therefore, the decoding unit 805 also uses β output from the estimating unit 801 for demodulating d₂(2). The decoding unit 805 also demodulates the data d₂(3), d₂(4), . . . for times t=3, 4, . . . in the same way.

When all data are prepared from the demodulation for performing turbo decoding, the decoding unit 805 performs the turbo decoding with the prepared data. As a result, the data d₂(2), d₂(3), d₂(4), . . . to the user terminal 122 (UE#2) may be obtained with high estimation accuracy. The decoding unit 805 outputs the decoded d₂(2), d₂(3), d₂(4), . . . to the SIC 806.

The SIC (successive interference canceller) 806 removes from the received signal, data for the user terminal 122 (#2). For example, for time t=2, the SIC 806 calculates βd₂(2), which is replica data based on d₂(2) output from the decoding unit 805 and β output from the estimating unit 801.

The SIC 806 performs computation according to equation (13) based on the calculated βd₂(2) and αd₁+βd₂ output from the dividing unit 804 and thereby obtains αd₁(2) obtained by removing the data to the user terminal 122 (#2) from the received signal.

{αd₁(2)+βd₂(2)}−βd₂(2) (13)

The SIC 806 executes the same process also for times t3, t4, . . . to obtain αd₁(3), αd₁(4), . . . . The SIC 806 outputs the obtained αd₁(2), αd₁(3), . . . to the decoding unit 807 as a signal that is the received signal from which the signal to the user terminal 122 (#2) has been removed.

For time t=2, the decoding unit 807 demodulates the data d₁(2) to the user terminal 121 (UE#1) included in the received signal based on αd₁(2) output from the SIC 806 and a output from the estimating unit 801. The decoding unit 807 also demodulates the data d₁(3), d₁(4), . . . for times t=3, 4, . . . in the same way.

When all data are prepared from the demodulation for performing turbo decoding, the decoding unit 807 performs the turbo decoding with the prepared data. As a result, the data d₁(2), d₁(3), d₁(4), . . . to the user terminal 121 (UE#1) may be obtained with high estimation accuracy. The decoding unit 807 outputs the decoded data (UE#1 data).

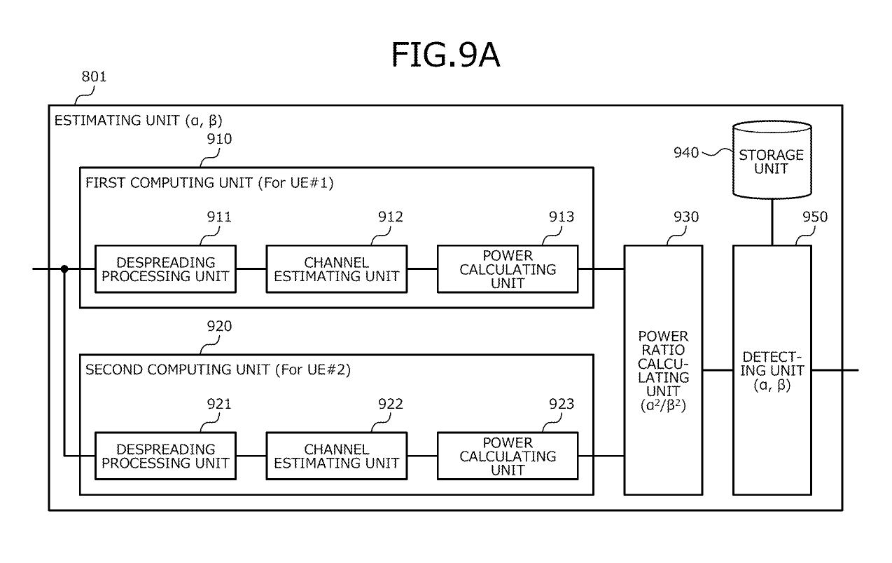

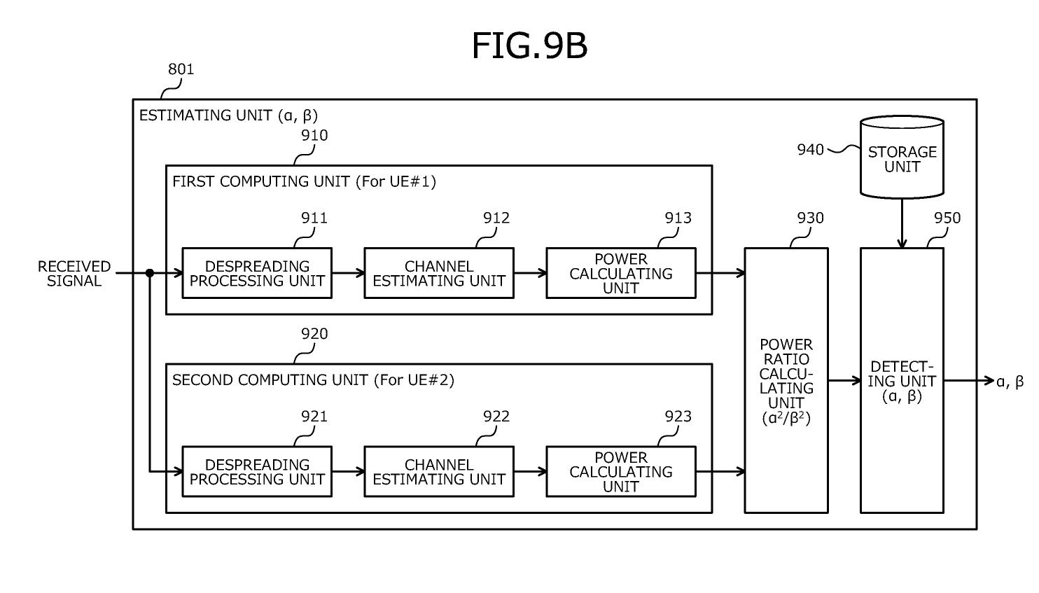

FIG. 9A is a diagram of an example of an estimating unit configured to estimate α, β. FIG. 9B is a diagram of an example of signal flow in the estimating unit depicted in FIG. 9A. As depicted in FIGS. 9A and 9B, the estimating unit 801 for α and β includes a first computing unit 910, a second computing unit 920, a power ratio calculating unit 930, a storage unit 940, and a detecting unit 950.

The estimating unit 801 estimates α and β at t=0, 1. The received signal input to the estimating unit 801 is represented by equations (2) and (3).

The first computing unit 910 computes transmission power related to the user terminal 121 (UE#1). For example, the first calculating unit 910 includes a despreading processing unit 911, a channel estimating unit 912, and a power calculating unit 913.

The second computing unit 920 computes transmission power related to the user terminal 122 (UE#2). For example, the second computing unit 920 includes a despreading processing unit 921, a channel estimating unit 922, and a power calculating unit 923.

The despreading processing unit 911 executes a despreading process and zero-forcing (ZF) for the user terminal 121 (UE#1) based on the received signal input to the estimating unit 801. The ZF is a process of canceling a cell-specific sequence. The despreading process for the user terminal 121 (UE#1) by the despreading processing unit 911 is executed as represented by equation (14), for example.

$$\begin{matrix}{h}_{1}^{( ZF 1 )} = \frac{1}{2} \{ \frac{{z}_{1} ( 0 )}{{c}_{1} ( 0 ) {x}_{1}} + \frac{{z}_{1} ( 1 )}{{c}_{1} ( 1 ) {x}_{1}} \} \\ = \frac{1}{2} \{ {h}_{1} ( 0 ) α + {h}_{1} ( 1 ) α + {h}_{1} ( 0 ) β \frac{{c}_{2} ( 0 ) {x}_{2}}{{c}_{1} ( 0 ) {x}_{1}} + {h}_{1} ( 1 ) β \frac{{c}_{2} ( 1 ) {x}_{2}}{{c}_{1} ( 1 ) {x}_{1}} \}\end{matrix} \qquad ( 14 )$$

If variation is sufficiently gradual between t=0 and t=1, approximation may be achieved as represented by equation (15), so that equation (14) described above is expressed as equation (16).

$$\begin{matrix}{h}_{1} ( 0 ) \approx {h}_{1} ( 1 ) & ( 15 ) \\ {h}_{1}^{( ZF 1 )} = α {h}_{1} ( 0 ) + \frac{1}{2} β {h}_{1} ( 0 ) \{ \frac{{c}_{2} ( 0 ) {x}_{2}}{{c}_{1} ( 0 ) {x}_{1}} + \frac{{c}_{2} ( 1 ) {x}_{2}}{{c}_{1} ( 1 ) {x}_{1}} \} & ( 16 )\end{matrix}$$

Since equation (17) holds and a signal is transmitted from the base station 110 such that equation (18) is satisfied, equation (17) described above is expressed as equation (19). It is note that * denotes a complex conjugate.

$$\begin{matrix}\frac{{c}_{2} ( 0 ) {x}_{2}}{{c}_{1} ( 0 ) {x}_{1}} + \frac{{c}_{2} ( 1 ) {x}_{2}}{{c}_{1} ( 1 ) {x}_{1}} = \frac{{c}_{1}^{*} ( 0 ) {c}_{2} ( 0 ) {x}_{1}^{*} {x}_{2}}{{\vert {c}_{1} ( 0 ) {x}_{1} \vert}^{2}} + \frac{{c}_{1}^{*} ( 1 ) {c}_{2} ( 1 ) {x}_{1}^{*} {x}_{2}}{{\vert {c}_{1} ( 1 ) {x}_{1} \vert}^{2}} & ( 17 ) \\ {\vert {c}_{1} ( 0 ) {x}_{1} \vert}^{2} = {\vert {c}_{1} ( 1 ) {x}_{1} \vert}^{2} = {\vert {c}_{2} ( 0 ) {x}_{2} \vert}^{2} = {\vert {c}_{2} ( 2 ) {x}_{2} \vert}^{2} & ( 18 ) \\ \frac{\{ {c}_{1}^{*} ( 0 ) {c}_{2} ( 0 ) + {c}_{1}^{*} ( 1 ) {c}_{2} ( 1 ) \} {x}_{1}^{*} {x}_{2}}{{\vert {c}_{1} ( 0 ) {x}_{1} \vert}^{2}} & ( 19 )\end{matrix}$$

Furthermore, since an orthogonal sequence is used, equation (20) holds, so that equation (19) described above is zero. Therefore, equation (16) described above representative of the result of the despreading process for the user terminal 121 (UE#1) by the despreading processing unit 911 is expressed as equation (21).

c₁*(0)c₂(0)+c₁*(1)c₂(1)=0 (20)

h₁^{(ZF1)}=αh₁(0) (21)

The despreading processing unit 911 outputs to the channel estimating unit 912, the signal obtained from the despreading process.

Similarly, the result of the despreading processing for the user terminal 122 (UE#2) by the despreading processing unit 921 is expressed as equation (22).

$$\begin{matrix}{h}_{1}^{( ZF 2 )} = \frac{1}{2} \{ \frac{{z}_{1} ( 0 )}{{c}_{2} ( 0 ) {x}_{2}} + \frac{{z}_{1} ( 1 )}{{c}_{2} ( 1 ) {x}_{2}} \} \\ = \frac{1}{2} \{ {h}_{1} ( 0 ) β + {h}_{1} ( 1 ) β + {h}_{1} ( 0 ) α \frac{{c}_{1} ( 0 ) {x}_{1}}{{c}_{2} ( 0 ) {x}_{2}} + {h}_{1} ( 1 ) α \frac{{c}_{1} ( 1 ) {x}_{1}}{{c}_{2} ( 1 ) {x}_{2}} \} \\ = β {h}_{1} ( 0 )\end{matrix} \qquad ( 22 )$$

The despreading processing unit 921 outputs to the channel estimating unit 922, the signal obtained from the despreading process.

In this case, since the noise component is ignored, the noise component is not included in this form. In actuality, the noise component is included and, therefore, noise is removed by the channel estimating unit. Although various channel estimation methods exist, for example, the channel estimating unit 912 may remove the noise component by averaging h₁^{(ZF1)} which is a despreading result calculated by the despreading processing unit 911, so as to estimate a highly accurate propagation path value. The averaging performed by the despreading processing unit 911 is, for example, averaging in the time direction or the frequency direction. The channel estimating unit 912 outputs to the power calculating unit 913, a channel estimation result H₁^{(ZF1)} obtained by the averaging.

Similarly, the channel estimating unit 922 may remove the noise component by averaging h₁^{(ZF2)} that is a despreading result calculated by the despreading processing unit 921 in the time direction or the frequency direction, so as to estimate a highly accurate propagation path value. The channel estimating unit 922 outputs to the power calculating unit 923, a channel estimation result H₁^{(ZF2)} obtained by the averaging.

The power calculating unit 913 calculates |H₁^{(ZF1)}|², which is the power based on H₁^{(ZF1)} calculated by the channel estimating unit 912 and outputs the calculated |H₁^{(ZF1)})|² to the power ratio calculating unit 930. Similarly, the power calculating unit 923 calculates |H₁^{(ZF2)}|², which is the power based on H₁^{(ZF2)} calculated by the channel estimating unit 922 and outputs the calculated |H₁^{(ZF2)}|² to the power ratio calculating unit 930.

Assuming that the noise component is eliminated by the averaging, equations (23) and (24) hold. Therefore, the power ratio calculating unit 930 may calculate α²/β²=η as equation (25) by performing division of the powers calculated by the power calculating units 913, 923. The power ratio calculating unit 930 outputs the calculated α²/β² to the detecting unit 950.

$$\begin{matrix}{\vert {H}_{1}^{( ZF 1 )} \vert}^{2} = {\vert {h}_{1}^{( ZF 1 )} \vert}^{2} = {α}^{2} {\vert {h}_{1} ( 0 ) \vert}^{2} & ( 23 ) \\ {\vert {H}_{1}^{( ZF 2 )} \vert}^{2} = {\vert {h}_{1}^{( ZF 2 )} \vert}^{2} = {β}^{2} {\vert {h}_{1} ( 0 ) \vert}^{2} & ( 24 ) \\ \frac{{\vert {H}_{1}^{( ZF 1 )} \vert}^{2}}{{\vert {H}_{1}^{( ZF 2 )} \vert}^{2}} = \frac{{α}^{2}}{{β}^{2}} = η & ( 25 )\end{matrix}$$

The storage unit 940 stores the candidates of the ratio of transmission powers to the user terminals 121, 122 set in the communications system 100 depicted in FIG. 3, for example. The detecting unit 950 detects the ratio closest to the α²/β² (power ratio) output from the power ratio calculating unit 930, among the candidates of the ratio of transmission powers to the user terminals 121, 122 stored in the storage unit 940. The detecting unit 950 outputs α, β, based on the detected ratio.

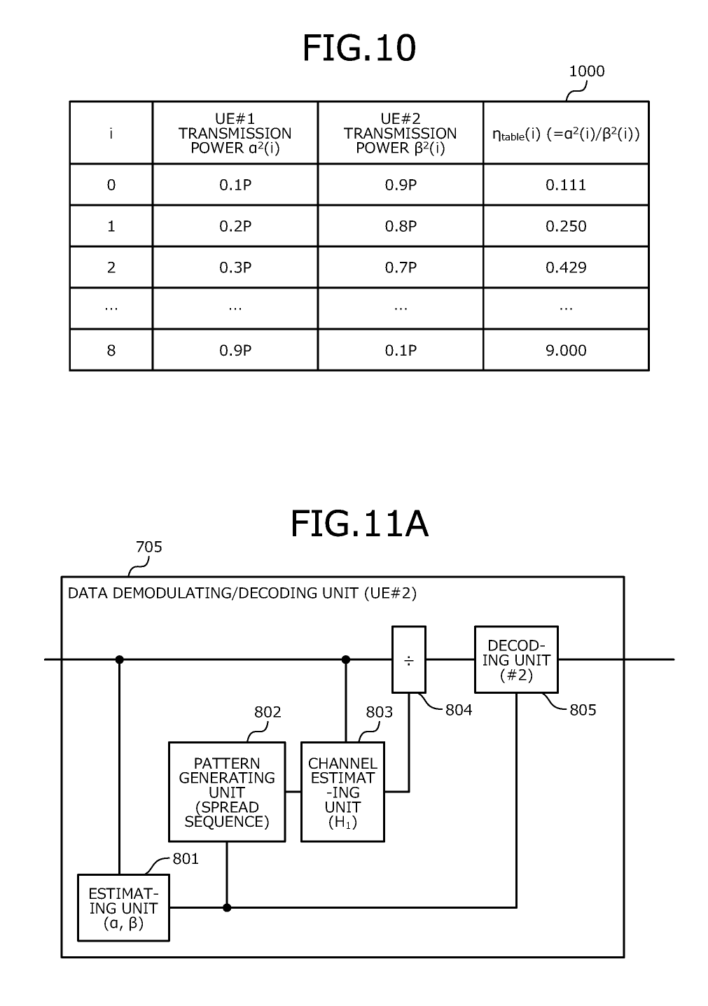

FIG. 10 is a diagram of an example of information stored in the storage unit. In the storage unit 940 depicted in FIGS. 9A and 9B, a table 1000 depicted in FIG. 10, for example, is stored. The table 1000 is information corresponding to the table 300 depicted in FIG. 3, for example, and is transmitted from the base station 110, for example, and stored in the storage unit 940.

In the table 1000, η_{table} is the ratio (η) of the respective transmission powers to the user terminals 121, 122. The table 1000 is created such that transmission powers corresponding to the multiple candidates of η_{table} are equally spaced in terms of magnitude. For example, in the example depicted in FIG. 10, the table 1000 is created such that the magnitude of the transmission powers to the user terminals 121, 122 is changed by 0.1P every time the value of the index i increases by one. For example, the detecting unit 950 identifies an index I at which α²/β² (η) output from the power ratio calculating unit 930 and η_{table} are closest to each other among the indices i (0 to 8) as represented by equation (26) and detects α² and β² as represented by equations (27) and (28).

$$\begin{matrix}I = arg {min}_{i} {\vert η - {η}_{table} ( i ) \vert}^{2} & ( 26 ) \\ {α}^{2} = {α}^{2} ( I ) & ( 27 ) \\ {β}^{2} = {β}^{2} ( I ) & ( 28 )\end{matrix}$$

The detecting unit 950 then converts the power values α², β² into amplitude values α, β as represented by equations (29) and (30) and outputs the converted α and β.

α=\sqrt{α²(I)} (29)

β=\sqrt{β²(I)} (30)

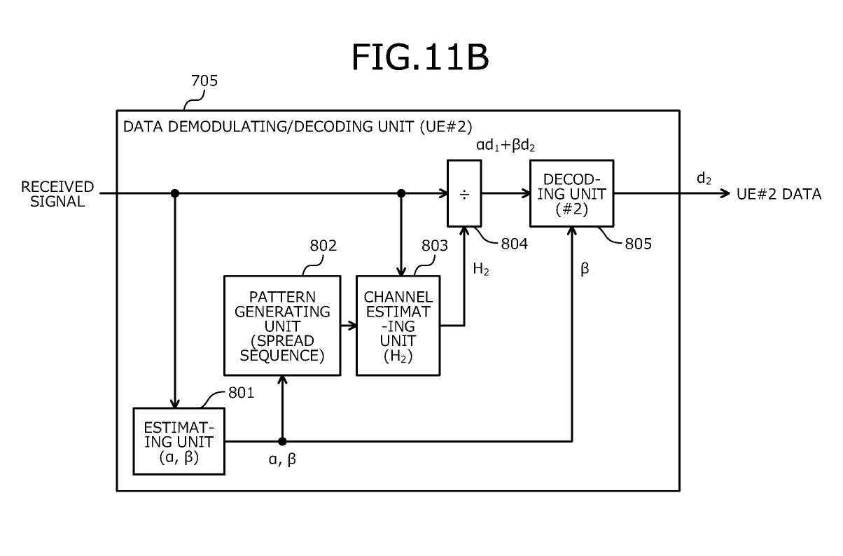

FIG. 11A is a diagram of an example of the data demodulating/decoding unit of the user terminal (UE#2). FIG. 11B is a diagram of an example of signal flow in the data demodulating/decoding unit depicted in FIG. 11A. In FIGS. 11A and 11B, portions identical to those depicted in FIGS. 8A and 8B are denoted by the same reference numerals used in FIGS. 8A and 8B and will not be described.

As depicted in FIGS. 11A and 11B, the data demodulating/decoding unit 705 of the user terminal 122 (UE#2) has a configuration obtained by omitting the SIC 806 and the decoding unit 807 from the configuration of the user terminal 121 (UE#1) depicted in FIGS. 8A and 8B. It is noted that although the user terminal 122 depicted in FIGS. 7A and 7B has a configuration compatible with OFDM, the description will be made with respect to one certain frequency (one subcarrier) (see, for example, FIG. 5).

The signal output from the OFDM signal processing unit 703 is input as a received signal to the estimating unit 801, the channel estimating unit 803, and the dividing unit 804. Received signals z₂(0), z₂(1), z₂(2) at times t=0, 1, 2 in the user terminal 122 are expressed by equations (31) to (33). The noise component is ignored.

z₂(0)=h₂(0){αc₁(0)x₁+βc₂(0)x₂} (31)

z₂(1)=h₂(1){αc₁(1)x₁+βc₂(1)x₂} (32)

z₂(2)=h₂(2){αd₁(2)+βd₂(2)} (33)

The estimating unit 801 of the user terminal 122 estimates α and β from the received signals z₂(0), z₂(1) for times t=0, 1. An estimating process by the estimating unit 801 is the same as the estimating process by the estimating unit 801 of the user terminal 121 described above. The estimating unit 801 outputs the estimated α and β to the pattern generating unit 802. The estimating unit 801 also outputs the estimated β to the decoding unit 805.

The pattern generating unit 802 of the user terminal 122 is the same as the pattern generating unit 802 of the user terminal 121. Based on the received signals z₂(0), z₂(1) at times t=0, 1 and the sequences output from the pattern generating unit 802, the channel estimating unit 803 of the user terminal 122 calculates propagation path values h₂(0), h₂(1) between the base station 110 and the user terminal 122 at time t=0, 1. For example, the channel estimating unit 803 calculates h₂(0), h₂(1) from equations (34) and (35).

$$\begin{matrix}\frac{{z}_{2} ( 0 )}{α {c}_{1} ( 0 ) {x}_{1} + β {c}_{2} ( 0 ) {x}_{2}} = {h}_{2} ( 0 ) & ( 34 ) \\ \frac{{z}_{2} ( 1 )}{α {c}_{1} ( 1 ) {x}_{1} + β {c}_{2} ( 1 ) {x}_{2}} = {h}_{2} ( 1 ) & ( 35 )\end{matrix}$$

Although the noise component is ignored in equations (34) and (35), the noise component cannot be ignored in the actual environment. A process of reducing the noise component is generally executed in the channel estimation. The case of using the channel estimation will be described as an example of the process of reducing the noise component.

If variation in the propagation path between the base station 110 and the user terminal 122 is sufficiently gradual variation between t=0 and t=1, a channel estimation value H₂ between the base station 110 and the user terminal 122 may be obtained by averaging the propagation path values h₂(0), h₂(1) as represented by equation (36).

$${H}_{2} = \frac{{h}_{2} ( 0 ) + {h}_{2} ( 1 )}{2} \qquad ( 36 )$$

The channel estimating unit 803 outputs to the dividing unit 804, the H₂ obtained from equation (36) as the channel estimation value.

To obtain the data at time t=2, the dividing unit 804 of the user terminal 122 performs division according to equation (37) based on the received signal z₂(2) for time t=2 and H₂ output from the channel estimating unit 803.

$$\frac{{y}_{2} ( 2 )}{{H}_{2}} = \frac{{h}_{2} ( 2 ) \{ α {d}_{1} ( 2 ) + β {d}_{2} ( 2 ) \}}{{H}_{2}} \qquad ( 37 )$$

If the channel variation is sufficiently gradual, equation (38) holds whereby equation (37) described above is expressed as equation (39).

$$\begin{matrix}{h}_{2} ( 2 ) \approx {H}_{2} & ( 38 ) \\ \frac{{y}_{2} ( 2 )}{{H}_{2}} = α {d}_{1} ( 2 ) + β {d}_{2} ( 2 ) & ( 39 )\end{matrix}$$

Therefore, the dividing unit 804 may obtain αd₁+βd₂ from the division according to equation (37) as a signal that is the received signal compensated with the channel estimation value. The dividing unit 804 outputs to the decoding unit 805, αd₁+βd₂ obtained from the division. The decoding unit 805 of the user terminal 122 is the same as the decoding unit 805 of the user terminal 121. The decoding unit 805 outputs the decoded data (UE#2 data).

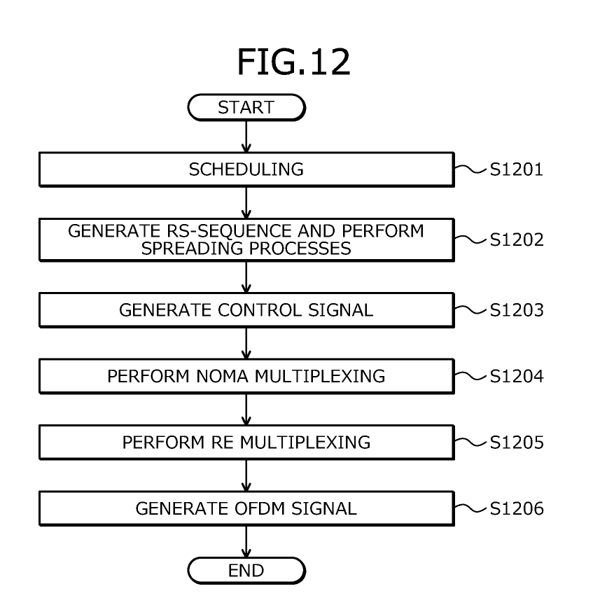

FIG. 12 is a flowchart of an example of a process by the base station. The base station 110 repeatedly executes steps depicted in FIG. 12, for example. First, the base station 110 performs scheduling for the user terminals 121, 122 (step S1201). The base station 110 then performs RS-sequence generating and spreading processes (step S1202).

The base station 110 generates a control signal (step S1203). The base station 110 performs NOMA multiplexing of data for the user terminals 121, 122 (step S1204). The base station 110 then performs RE multiplexing of the RS sequences subjected to the spreading process at step 1202, the control signal generated at step S1203, and the data signal NOMA-multiplexed at step S1204 (step S1205).

Subsequently, the base station 110 generates an OFDM signal based on the signal obtained by the RE multiplexing at step S1205 (step S1206) and terminates the series of operations. The OFDM signal generated at step S1206 is subjected to the RF process by the RF processing unit 608 and transmitted by radio through the antenna 609.

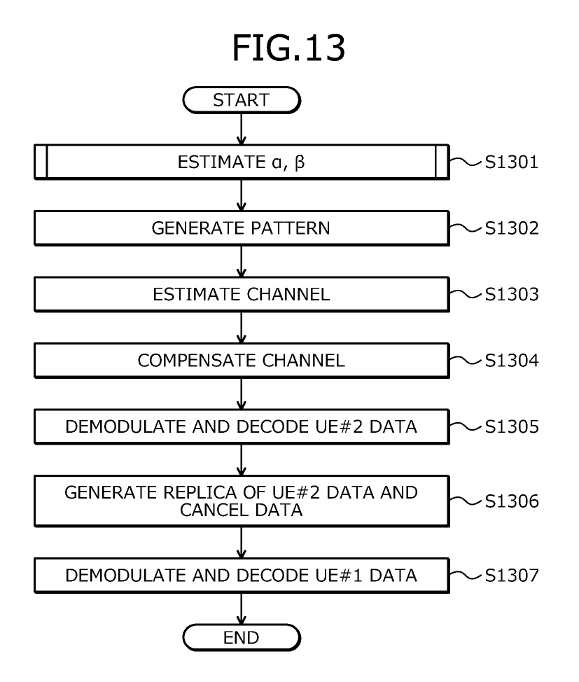

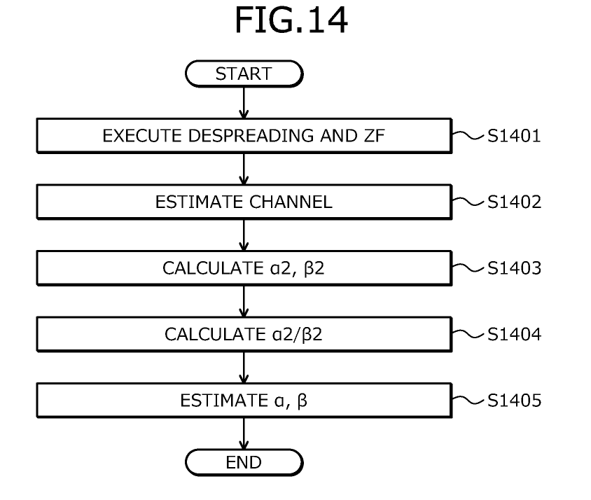

FIG. 13 is a flowchart of an example of a process by the user terminal (UE#1). The user terminal 121 (UE#1) repeatedly executes steps depicted in FIG. 13, for example. First, the user terminal 121 estimates α, β based on the received signal from the base station 110 (step S1301). The process of estimating α, β will be described later (see, for example, FIG. 14). The user terminal 121 then generates a pattern based on α, β estimated at step S1301 (step S1302). The user terminal 121 performs the channel estimation based on the pattern generated at step S1302 (step S1303).

Subsequently, the user terminal 121 performs the channel compensation of the received signal based on the channel estimation result at step S1303 (step S1304). The user terminal 121 then demodulates and decodes the data (UE#2 data) of the user terminal 122 included in the received signal (step S1305).

Subsequently, the user terminal 121 generates a replica of the data (UE#2 data) of the user terminal 122 decoded at step S1305 and uses the generated replica to cancel the data of the user terminal 122 from the received signal (step S1306). The user terminal 121 then demodulates and decodes the data (UE#1 data) of the user terminal 121 obtained by the canceling at step S1306 (step S1307) and terminates the series of operations.

FIG. 14 is a flowchart of an example of the process of estimating α, β. For example, at step S1301 depicted in FIG. 13, the user terminal 121 estimates α, β by executing the steps depicted in FIG. 14. First, the user terminal 121 executes the despreading process (despreading and ZF) for the received signal for each of the user terminals 121, 122 (step S1401). The user terminal 121 then performs the channel estimation for each of the user terminals 121, 122 based on the signal subjected to the despreading process at step S1401 (step S1402).

Subsequently, the user terminal 121 calculates α², β², which are the power values based on the result of the channel estimation at step S1402 (step S1403). The user terminal 121 calculates α²/β² based on α², β² calculated at step S1403 (step S1404). The user terminal 121 then estimates α, β selected by the base station 110 based on α²/β² calculated at step S1404 (step S1405) and terminates the series of operations.

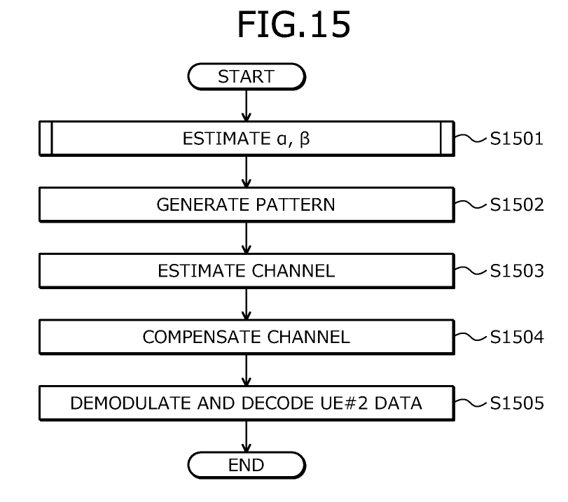

FIG. 15 is a flowchart of an example of a process by the user terminal (UE#2). The user terminal 122 (UE#2) repeatedly executes steps depicted in FIG. 15, for example. Steps S1501 to S1505 depicted in FIG. 15 are the same as steps S1301 to S1305 depicted in FIG. 13.

In the examples depicted in FIGS. 3 and 10, the case of setting candidates changed by 0.1 with respect to the ratio of transmission powers to the user terminals 121, 122 has been described. However, such setting is not always optimal for the process on the receiving side.

For example, in the examples depicted in FIGS. 3 and 10, η_{table}(i+1)−η_{table}(i) becomes larger as the index i increases. Since the noise amount of the estimated η does not depend on the index i, the possibility of erroneous determination at the detecting unit 950 increases at i for which η_{table}(i+1)−η_{table}(i) becomes smaller. Therefore, a table may be created such that ratios of multiple candidates are equally spaced in terms of magnitude.

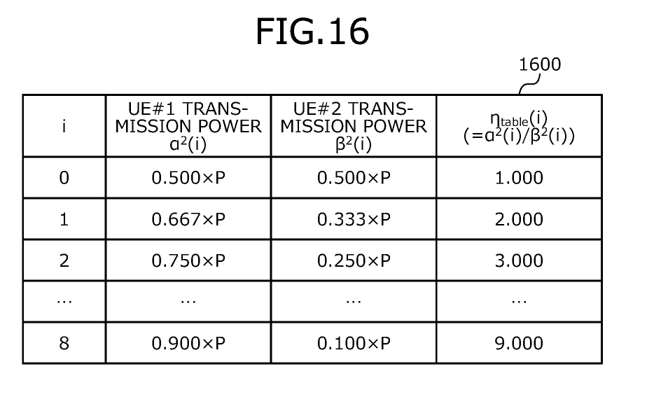

FIG. 16 is a diagram of a modification example of the information stored in the storage unit. In the storage unit 940 depicted in FIGS. 9A and 9B, for example, a table 1600 depicted in FIG. 16 may be stored. In this case, the table 300 depicted in FIG. 3 is also set to indicate the ratio of transmission powers to the user terminals 121, 122 described in the table 1600. The table 1600 indicates multiple candidates of η_{table} equally spaced in terms of magnitude.

The table 1600 is created such that η_{table}(i+1)−η_{table}(i) becomes constant without depending on the index i. It is assumed that α²(i)=a(i)P and β²(i)=b(i)P are satisfied. Since a(i)+b(i)=1 and η_{table}(i)=a(i)/b(i), equations (40) and (41) are obtained.

$$\begin{matrix}a ( i ) = \frac{{η}_{table} ( i )}{1 + {η}_{table} ( i )} & ( 40 ) \\ b ( i ) = \frac{1}{1 + {η}_{table} ( i )} & ( 41 )\end{matrix}$$

In the configuration described with reference to FIGS. 8A, 8B, 11A, and 11B, the channel estimation is performed by using the spread sequence at the data demodulating/decoding unit 705. In contrast, the channel estimation may be performed after despreading at the data demodulating/decoding unit 705.

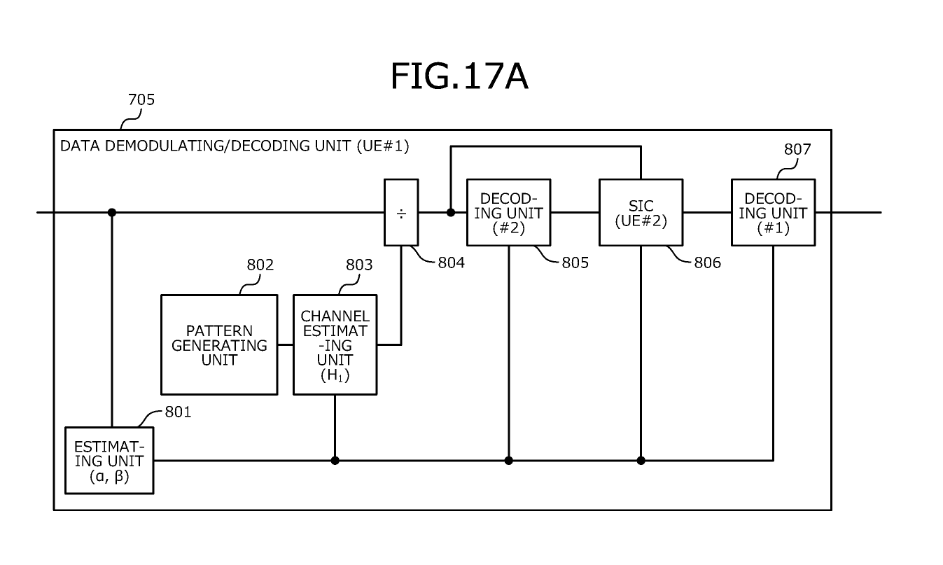

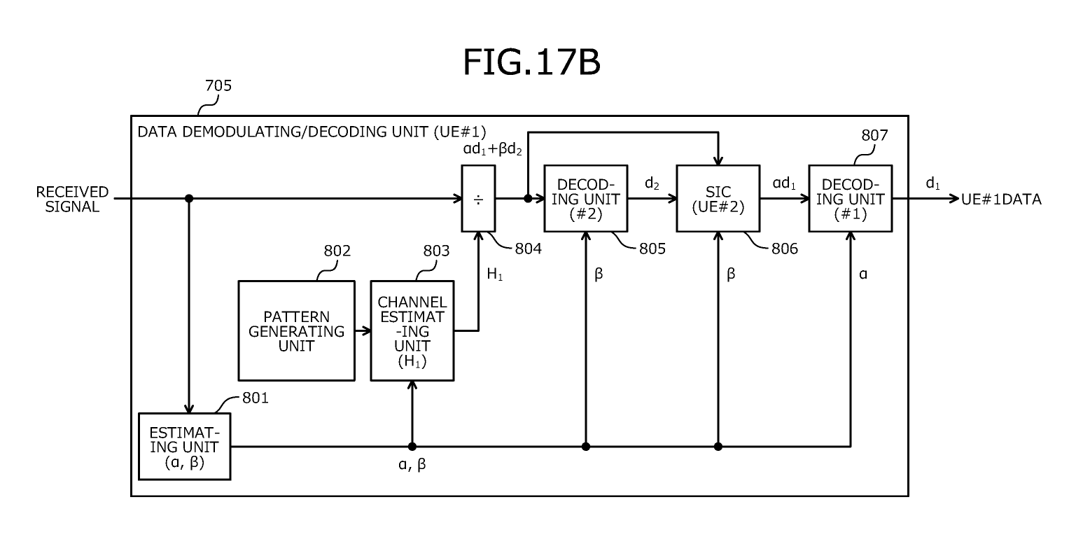

FIG. 17A is a diagram of a modification example of the data demodulating/decoding unit of the user terminal (UE#1). FIG. 17B is a diagram of an example of signal flow in the modification example of the data demodulating/decoding unit depicted in FIG. 17A. In FIGS. 17A and 17B, constituent elements identical to those in FIGS. 8A and 8B are denoted by the same reference numerals used in FIGS. 8A and 8B and will not be described. As depicted in FIGS. 17A and 17B, in the data demodulating/decoding unit 705 of the user terminal 121 (UE#1), the estimating unit 801 may output α, β to the channel estimating unit 803 without outputting α, β to the pattern generating unit 802.

In this case, the pattern generating unit 802 generates the sequence for time t=0 according to equations (42) and (43) and generates the sequence (pattern) for time t=1 according to equations (44) and (45).

c₁(0)x₁ (42)

c₂(0)x₂ (43)

c₁(1)x₁ (44)

c₂(1)x₂ (45)

The channel estimating unit 803 executes a despreading process by using the pattern generated by the pattern generating unit 802 and performs the channel estimation. The process by the channel estimating unit 803 in this case is the same as the process by the estimating unit 801 represented by equations (14) and (22), for example. Additionally, to improve the channel estimation accuracy, the channel estimating unit 803 executes the channel estimating process for removing the noise component to obtain H₁^{(ZF1)}), H₁^{(ZF2)}).

As can be seen from equations (21) and (22), a difference between these two channel estimation values is the difference whether h₁(0) is multiplied by α or β, and only the magnitude of amplitude is different. This means that since these values commonly include the propagation path value h₁(0), these two channel estimation values may be utilized effectively to further improve the estimation accuracy. For example, the channel estimating unit 803 may improve the channel estimation accuracy by performing maximal ratio combining represented by equation (46).

αH₁^{(ZF1)}+βH₁^{(ZF2)} (46)

However, the process represented by equation (46) is a process when noise powers included in the channel estimation results H₁^{(ZF1)}, H₁^{(ZF2)} are the same and uncorrelated. If such a condition cannot be assumed, the channel estimating unit 803 may estimate the noise powers with an arbitrary method before performing the maximal ratio combining, for example.

The channel estimating unit 803 may obtain a signal of equation (47) based on the result of the maximum ratio combining. Since it is assumed that H₁ is input into the dividing unit 804, the channel estimating unit 803 outputs to the dividing unit 804, a result of dividing the signal of equation (47) by (α²+β²) as H₁.

α(αh₁(0))+β(βh₁(0))=(α²+β²)h₁(0) (47)

Although a modification example of the data demodulating/decoding unit 705 of the user terminal 121 depicted in FIGS. 8A and 8B has been described with reference to FIGS. 17A and 17B, the same modification is applicable to the data demodulating/decoding unit 705 of the user terminal 122 depicted in FIGS. 11A and 11B.

As described above, according to the first embodiment, the base station 110 uses orthogonal codes to spread the RSs to the user terminals 121, 122 to be non-orthogonally multiplexed before transmission, so as to make the transmission powers of the RSs the same as the data signals to the user terminals 121, 122. Based on the RSs from the base station 110, the user terminals 121, 122 estimate the respective transmission powers of the data signals to the user terminals 121, 122, and perform the channel estimation based on the estimated respective transmission powers.

As a result, the power control information required for demodulation may be reduced. For example, even though the respective transmission powers of the data to the non-orthogonally multiplexed user terminals 121, 122 are not reported to the user terminals 121, 122 through the power control information using the control channel, the user terminals 121, 122 may demodulate the non-orthogonally multiplexed data.

Additionally, even though the respective transmission powers of the data to the non-orthogonally multiplexed user terminals 121, 122 are not reported to the user terminals 121, 122 through the power control information using the control channel, the channel estimation may be performed with high accuracy.

Although the base station 110 makes the respective transmission powers of the RSs to the user terminals 121, 122 the same as the respective transmission powers of the data signals to the user terminals 121, 122 in the case described above, the respective transmission powers of the RSs may be transmission powers corresponding to the respective transmission powers of the data signals. In this case, by sharing correspondence information of the respective transmission powers of the RSs and the respective transmission powers of the data signals between the base station 110 and the user terminals 121, 122, the user terminals 121, 122 may estimate the respective transmission powers of the data signals from the respective transmission powers of the RSs.

A second embodiment will be described in terms of portions different from the first embodiment. In the case described in the first embodiment, the base station 110 spreads the RSs to the user terminals 121, 122 with orthogonal codes for multiplexing before transmission. However, the method of multiplexing and transmitting the RSs is not limited thereto and may be any transmission method with which the RSs may be demultiplexed in the user terminals 121, 122. In the second embodiment, description will be made of a case where the base station 110 transmits the RSs to the user terminals 121, 122 through at least one of time multiplexing and frequency multiplexing.

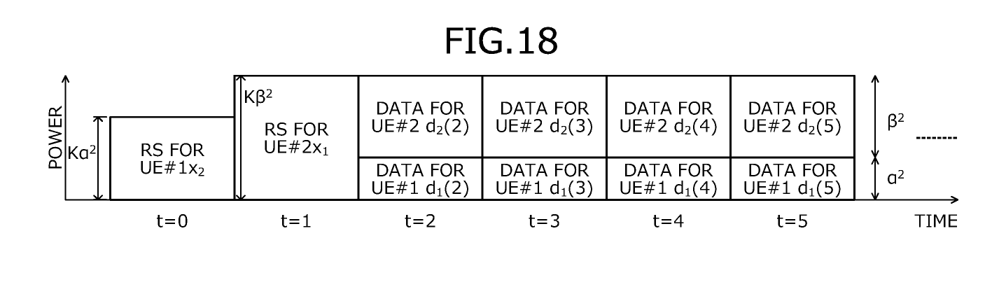

FIG. 18 is a diagram of an example of signals transmitted by the base station according to the second embodiment. In FIG. 18, portions identical those depicted in FIG. 5 will not be described. As depicted in FIG. 18, at time t=0, the base station 110 according to the second embodiment transmits x₂ that is an RS (RS for UE#1) to the user terminal 121. At time t=1, the base station 110 transmits x₁ that is an RS (RS for UE#2) to the user terminal 122. In this way, the base station 110 transmits the RSs to the user terminals 121, 122 with resources orthogonal on the time axis (or the frequency axis).

Additionally, the base station 110 may set the transmission power of x₂, which is the RS to the user terminal 121, to Kα² obtained by multiplying the transmission power of the data d₁ (2), d₁(3), . . . for the user terminal 121 by K (K>1). As a result, the RSs (pilot signals) may be transmitted with respective transmission powers higher than the respective transmission powers of the data.

The base station 110 may set the transmission power of x₁, which is the RS to the user terminal 122, to Kβ² obtained by multiplying the transmission power of the data d₂(2), d₂ (3), . . . for the user terminal 122 by K.

Since x₁ may be x₂ (x₁=x₂), it is assumed hereinafter that x=x₁=x₂ is satisfied. In this case, the received signals of the user terminal 121 at time t=0, 1 are represented by equations (48) and (49).

y₁(0)=h₁(0)(Kαx(0)) (48)

y₁(1)=h₁(1)Kβx(1)) (49)

Therefore, when the user terminal 121 cancels the RS pattern, signals of equations (50) and (51) are obtained.

$$\begin{matrix}{h}_{1}^{( ZF 1 )} = \frac{{y}_{1} ( 0 )}{x ( 0 )} = K α {h}_{1} ( 0 ) & ( 50 ) \\ {h}_{1}^{( ZF 2 )} = \frac{{y}_{1} ( 1 )}{x ( 1 )} = K β {H}_{1} ( 1 ) & ( 51 )\end{matrix}$$

The estimating unit 801 of the user terminal 121 may estimate α and β by executing the same processes as those described with reference to FIGS. 8A and 8B based on the signals of equations (50) and (51).

It is assumed that channel estimation results after noise elimination in the channel estimation unit 803 are denoted by H₁^{(ZF1)}), H₁^{(ZF2)}. If temporal channel variation is small, equation (52) holds and, therefore, equations (53) and (54) hold.

h₁(0)=h₁(1) (52)

|H₁^{(ZF1)}|²=|h₁^{(ZF1)}|²=K²α²|h₁(0)|² (53)

|H₁^{(ZF2)}|²=|h₁^{(ZF2)}|²=K²β²|h₁(0)|² (54)

Therefore, the estimating unit 801 (the power ratio calculating unit 930) may perform division of the power values calculated from equations (53) and (54) to calculate α²/β²=η as in the case with equation (25) described above so as to estimate α, β.

As described above, according to the second embodiment, the base station 110 multiplexes the RSs to the user terminals 121, 122 to be non-orthogonally multiplexed in terms of at least one of time and frequency before transmission. The base station 110 sets the respective transmission powers of the RSs to the user terminals 121, 122 K times (K>1) as large as the respective transmission powers of the data signals for the user terminals 121, 122.

Based on the RSs from the base station 110, the user terminals 121, 122 estimate the respective transmission powers of the data signals to the user terminals 121, 122, and perform the channel estimation based on the estimated respective transmission powers. As a result, the power control information required for demodulation may be reduced as in the case with the first embodiment.

Additionally, by setting the respective transmission powers of the RSs to the user terminals 121, 122 K times (K>1) as large as the respective transmission powers of the data signals for the user terminals 121, 122, the respective transmission powers may be estimated accurately at the user terminals 121, 122. Therefore, the accuracy of the channel estimation may be improved.

Although the base station 110 sets the respective transmission powers of the RSs to the user terminals 121, 122 to be K times as large as the respective transmission powers of the data signals to the user terminals 121, 122 in the case described above, the respective transmission powers of the RSs may be transmission powers corresponding to the respective transmission powers of the data signals. In this case, by sharing correspondence information of the respective transmission powers of the RSs and the respective transmission powers of the data signals between the base station 110 and the user terminals 121, 122, the user terminals 121, 122 may estimate the respective transmission powers of the data signals from the respective transmission powers of the RSs.

As described above, according to the communications system and the communications method, the power control information required for demodulation may be reduced.

For example, in the NOMA system in “Concept and Practical Considerations of Non-orthogonal Multiple Access (NOMA) for Future Radio Access” proposed by Anass Benjebbour, et al, notification of 4-bit transmission power information, for example, has to be given to the user. It is assumed that NOMA is applied to a Long Term Evolution-Advanced (LTE-A) system that is an existing system.

In LTE-A, data may be assigned on the basis of Physical Resource Block (PRB) and, therefore, the user pair may be different for each PRB. Thus, four-bit transmission power information is reported for each PRB. Since the maximum number of PRBs is 100, 100×4=400 bits of control information are required.

If the 400 bits are transmitted by using the control channel of LTE-A, i.e., Physical Downlink Control Channel (PDCCH), since the original control information included in PDCCH of LTE-A is about 50 bits, the control information to be transmitted is increased by nine times to 450 bits. Therefore, the overhead of the control information is increased by nine times, so that a decrease in resources allocated to data results in decreased throughput.

According to the embodiments described above, RSs to the NOMA target UEs are spread with orthogonal codes to make the transmission powers of the RSs the same as those of the data signals to the UEs so as to enable the UEs to estimate the transmission powers from the RSs to perform the channel estimation. As a result, the control information required for demodulation may be reduced.

Conventionally, however, the transmission power of each of non-orthogonally multiplexed data is reported through power control information to each receiving station. Consequently, the conventional technique described above has a problem of increased power control information required for demodulation on the receiving side.

An aspect of the present invention produces an effect in that the power control information required for demodulation may be reduced.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communications system comprising:
a transmission station configured to transmit data to a plurality of reception stations by non-orthogonal multiplexing, the transmission station further configured to transmit pilot signals to the plurality of reception stations by respective transmission powers corresponding to respective transmission powers of the data; and
a reception station included in the plurality of reception stations and configured to estimate the respective transmission powers of the data based on the pilot signals transmitted by the transmission station, the reception station further configured to perform channel estimation between the transmission station and the reception station based on the estimated respective transmission powers.

2. The communications system according to claim 1, wherein
the reception station estimates the respective transmission powers of the pilot signals transmitted by the transmission station and estimates the respective transmission powers of the data transmitted by the transmission station, based on a ratio of the estimated respective transmission powers and information indicating a plurality of candidates of a ratio of the respective transmission powers used by the transmission station for the data to the plurality of reception stations.

3. The communications system according to claim 2, wherein
the information indicating the plurality of candidates is created such that transmission powers corresponding to the plurality of candidates are equally spaced in terms of magnitude.

4. The communications system according to claim 2, wherein
the information indicating the plurality of candidates is created such that ratios of the plurality of candidates are equally spaced in terms of magnitude.

5. The communications system according to claim 1, wherein
the reception station uses channel estimation to estimate the respective transmission powers of the pilot signals transmitted by the transmission station.

6. The communications system according to claim 1, wherein
the transmission station executes with respect to the pilot signals to the plurality of reception stations, a spreading process using orthogonal codes and transmits the pilot signals by transmission powers that are the same as the respective transmission powers of the data to the plurality of reception stations, and
the reception station uses the orthogonal codes to execute a despreading process of the pilot signals transmitted by the transmission station and based on a result of the despreading process, estimates the respective transmission powers of the data transmitted by the transmission station.

7. The communications system according to claim 6, wherein
the reception station generates based on an estimation result of the respective transmission powers of the data transmitted by the transmission station, signals corresponding to the pilot signals that are transmitted by the transmission station and that are spread with the orthogonal codes, the reception station performing channel estimation between the transmission station and the reception station based on the generated signals.

8. The communications system according to claim 1, wherein
the transmission station transmits the pilot signals to the plurality of reception stations by at least one of time multiplexing and frequency multiplexing of the pilot signals to the plurality of reception stations by transmission powers that are higher than the respective transmission powers of the data to the plurality of reception stations, and
the reception station demultiplexes the pilot signals transmitted by at least one of the time multiplexing and the frequency multiplexing by the transmission station, the reception station estimating the respective transmission powers of the data transmitted by the transmission station, based on the demultiplexed pilot signals.

9. The communications system according to claim 1, wherein
the reception station demodulates data to the reception station among the data transmitted by the non-orthogonal multiplexing by the transmission station, the reception station demodulating the data to the reception station, based on an estimation result of the respective transmission powers of the data transmitted by the transmission station.

10. A communications method comprising:
transmitting, by a transmission station, data to a plurality of reception stations by non-orthogonal multiplexing;
transmitting, by the transmission station, pilot signals to the plurality of reception stations by respective transmission powers corresponding to respective transmission powers of the data;
estimating, by a reception station included in the plurality of reception stations, the respective transmission powers of the data based on the pilot signals transmitted by the transmission station; and
performing, by the reception station, channel estimation between the transmission station and the reception station based on the estimated respective transmission powers.
